(19) United States
(12) Patent Application Publication
(10) Pub. No.: US 2020/0066120 A1
(43) Pub. Date: Feb. 27, 2020

(54) Emergency Message Alert and Monitoring Apparatus and System

(71) Applicant: Andy K.F. Kaoh, Costa Mesa, CA (US)

(72) Inventor: Andy K.F. Kaoh, Costa Mesa, CA (US)

(21) Appl. No.: 16/112,310

(22) Filed: Aug. 24, 2018

(51) Int. Cl. G08B 13/196; G06K 9/00; G10L 15/22

(52) U.S. Cl. CPC G08B 13/196; G10L 2015/223; G10L 15/22; G06K 9/00771

(57) ABSTRACT

An emergency message alert and monitoring apparatus and system are disclosed. The apparatus comprises detection devices such as microphones and cameras for monitoring an environment such as a classroom for an occurrence of an emergency. The apparatus may detect voice commands, gun shots, or the presence of unauthorized persons within the environment, and then indicate on a display an occurrence of an emergency. The system comprises one or more apparatuses distributed in a school or workplace which are in communication with a main central controller. The emergency message alert and monitoring apparatus and systems monitor information sources such as from television broadcasts, government emergency agencies for external emergencies which may impact the local environment.

### BACKGROUND OF THE INVENTION

### 1. Field of the Invention

The present invention relates in general to an alert and monitoring device. In particular, the invention is directed to an emergency message alert and monitoring apparatus.

### 2. Description of the Related Art

Emergencies which occur at schools and workplaces are, unfortunately, far too common in the United States and other places in the world. The first moments at the onset of an emergency are critically important as officials must first ascertain the existence of an emergency, and then determine the scope and nature of the emergency. Conventional schools and workplaces may have public address systems, and perhaps cameras monitoring key locations. However, the conventional approaches are often inadequate for detecting the scope and nature of emergencies quickly, which may delay the response to the emergency.

Accordingly, a need exists to provide apparatuses and systems for use during emergency situations.

### SUMMARY OF THE INVENTION

In the first aspect, an emergency message alert and monitoring apparatus is disclosed. The apparatus comprises a detection device for monitoring an environment, the detection device generating a detection electronic signal, and a controller coupled to the detection device receiving the detection electronic signal, the controller analyzing the detection electronic signal for an occurrence of an emergency, the controller communicating the occurrence of the emergency. The apparatus further comprises one or more display devices communicating with the controller, the one or more display devices providing indicia of the emergency to the environment.

In a first preferred embodiment, the detection device comprises a sound detection device monitoring the audio of an environment, and the detection electronic signal comprises a sound electronic signal. The controller preferably analyzes the sound electronic signal comprises detecting a voice command from person within the environment. The controller preferably analyzes the sound electronic signal comprises detecting a gun shot within the environment. The detection device preferably comprises a camera device monitoring the environment, and the detection electronic signal comprises a camera electronic signal. The controller analyzes the camera electronic signal preferably comprises recognizing and detecting the presence of unauthorized persons within the environment. The one or more display devices preferably comprise an electronic visual display, and one or more strobe lights. The emergency message alert and monitoring apparatus preferably further comprises a control box configured for communicating to the controller. The control box preferably comprises a smart device running an application.

In a second aspect, an emergency message alert and monitoring system is disclosed. The system comprises one or more emergency message alert and monitoring apparatuses, each apparatus comprising a detection device for monitoring an environment, the detection device generating a detection electronic signal, a controller coupled to the detection device receiving the detection electronic signal, the controller analyzing the detection electronic signal for an occurrence of an emergency, the controller communicating the occurrence of the emergency, and one or more display devices communicating with the controller, the one or more display devices providing indicia of the emergency to the environment. The system further comprises a main central controller communicating with each apparatus, the main central controller communicating with remote locations.

In a second preferred embodiment, the detection device comprises a sound detection device monitoring the audio of an environment, and the detection electronic signal comprises a sound electronic signal. The main central controller preferably triangulates and determines the location of a source of sounds by comparing the signal received from the apparatuses. When an occurrence of the emergency is detected by the one or more apparatuses, the main central controller immediately activates the one or more apparatuses, and communicating the occurrence to remote locations. The detection device of the one or more apparatuses preferably comprises a camera device monitoring the environment, and the detection electronic signal comprises a camera electronic signal. Each controller of the one or more apparatuses preferably analyzes the camera electronic signal comprises recognizing and detecting the presence of unauthorized persons within the environment. The one or more display devices of each of the apparatuses preferably comprise an electronic visual display, and one or more strobe lights.

In a third aspect, a method for monitoring an environment for occurrences of an emergency is disclosed. The method comprises providing an emergency message alert and monitoring apparatuses comprising a detection device for monitoring an environment, the detection device communicating a detection electronic signal, a controller coupled to the detection device receiving the detection electronic signal, and one or more display devices communicating with the controller, the one or more display devices providing indicia of the emergency within the environment. The method further comprises receiving the detection electronic signal by the controller, analyzing the detection electronic signal for an occurrence of an emergency within the environment, and providing an indication of an emergency occurring within the environment.

In a third preferred embodiment, the method further comprises providing a main central controller in communication with the apparatuses, and communicating the indication of an emergency to a main central controller. Analyzing the detection signal for an occurrence of an emergency within the environment preferably comprises analyzing the detection signal for a voice command. Analyzing the detection signal for an occurrence of an emergency within the environment preferably comprises analyzing the detection signal for images of an unauthorized person within the environment.

These and other features and advantages of the invention will become more apparent with a description of preferred embodiments in reference to the associated drawings.

### DESCRIPTION OF THE DRAWINGS

FIG. 1 is a front view of an Emergency Message Alert and Monitoring Apparatus.

FIG. 2 is a front view of the Emergency Message Alert and Monitoring Apparatus attached to a wall.

FIG. 3 is a front view of an Emergency Message Alert and Monitoring Apparatus employing a plurality of 16 segment LED displays.

FIG. 4 is a front view of an Emergency Message Alert and Monitoring Apparatus employing a matrix of LEDs.

FIG. 5 is a front view of an Emergency Message Alert and Monitoring Apparatus employing a display screen.

FIG. 6 is a back view of an Emergency Message Alert and Monitoring and Monitoring Apparatus.

FIG. 7 is a schematic, block diagram of the Emergency Message Alert and Monitoring Apparatus.

FIG. 8 is a flowchart illustrating an exemplary method for monitoring an environment for an emergency.

FIG. 9 is a schematic, block diagram of an Emergency Message Alert and Monitoring System comprising multiple apparatuses communicating with a main central controller.

### DETAILED DESCRIPTION OF THE PREFERRED EMBODIMENTS

In one or more embodiments, an emergency message and monitoring apparatus (“apparatus” hereafter) comprises a controller, input/output circuitry configured for communicating with remote devices, an illuminated display, strobe lights, a camera, a microphone, and a speaker. In one aspect, the emergency message alert and monitoring apparatus monitors information sources such as from television broadcasts, government emergency agencies, or the Internet for emergency events for example. When an emergency event is detected, the apparatus becomes activated and will alert people that an emergency is occurring by displaying a message on the illuminated display or by flashing the strobe lights.

In one or more embodiments, an emergency message and monitoring apparatus is also configured to monitor local environments such as classrooms for indications of emergencies. Such indications of emergencies may include detecting screams, gun shots, voice commands, or unauthorized persons within a local environment. For example, a microphone in the apparatus may continuously monitor background sounds, and may electronically recognize and distinguish the sounds of emergency events such as gun shots or screams in which the apparatus will display the appropriate emergency message, communicate the occurrence of the emergency event to remote devices, and activate the camera to visually monitor the scene near the apparatus.

In one or more embodiments, a control box may be used to communicate with the apparatus to signal that an emergency event is present. The control box may have several buttons such as for indicating that a fire, a shooting, or a medical emergency is occurring. In an embodiment, a smartphone may run a software application (“app”) which controls the apparatus.

One or more of the apparatuses can be combined with a Main Central Controller to form an emergency message and monitoring system (“system” hereafter). The system may have similar features to that of a public address system having a microphone and a speaker in the apparatus for communicating with the Main Central Controller.

Teachings relating to the message alert apparatus disclosed in U.S. patent application Ser. No. 11/057,609 filed Feb. 14, 2005 entitled “MESSAGE SIGN ALERT DEVICE AND METHOD” which was issued as U.S. Pat. No. 7,262,707 on Aug. 28, 2007 may be employed herein and the disclosure of which is incorporated herein by reference in its entirety. While embodiments disclosed herein may refer to the apparatuses and systems being employed within a school or classroom environment, it shall be understood that these environments are exemplary and are non-limiting, and the apparatuses, systems, and devices described herein may also be employed in other environments such as within office buildings, public or private venues, hotels, or apartment or condominiums for example.

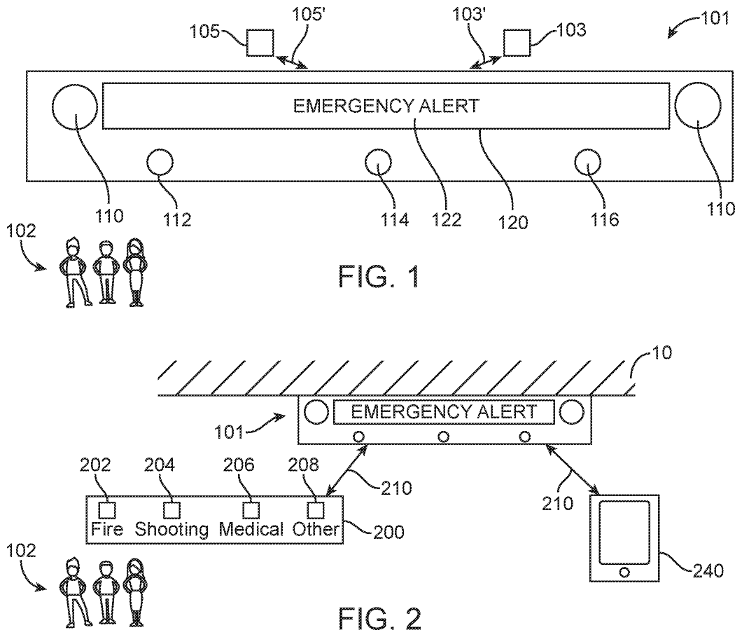

FIG. 1 is a front view of an Emergency Message Alert and Monitoring Apparatus 101. In an embodiment, the apparatus comprises a display 120, a display message 122, one or more strobe lights 110, a sound detection device such as a microphone 112, a speaker 116, a camera 114, a controller 340, and input/output circuitry 332 for communicating with remote devices (see FIG. 7). While input/output circuitry 332 is shown for illustration purposes, it shall be understood that other circuits for communicating between the controller 340 and other devices are contemplated in one or more embodiments.

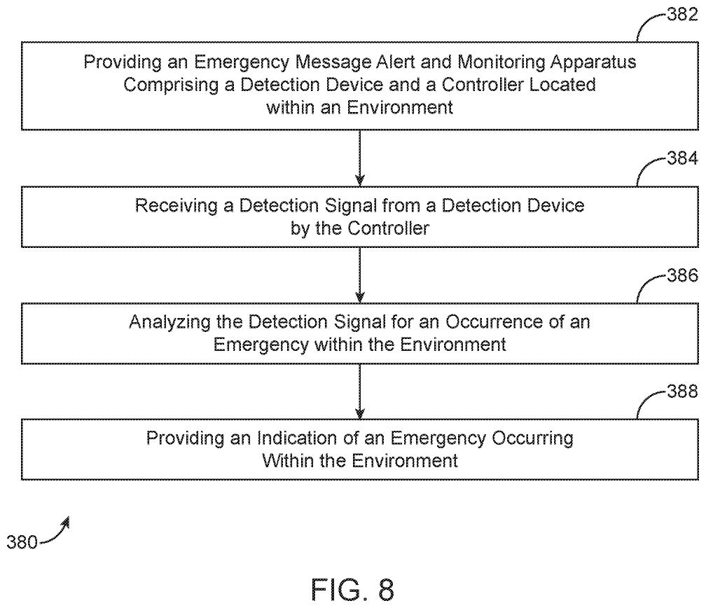

As discussed below, the apparatus has the capability of communicating directly with remote, outside sources 103 and 105 through communication links 103′ and 105′ as well as to a Main Central Controller 410 as shown in FIG. 8. In one or more embodiments, the apparatus 101 may be in communication with one or more emergency information sources 103 and 105 which may include public or private agencies, or may include government agencies such as the Emergency Alert System formally known as the Emergency Broadcast System. Other information sources 105 may include television or radio broadcasts, and internet sources.

When activated, a message such as “EMERGENCY ALERT” will be displayed, and the strobe lights 110 will be illuminated. The display may be comprised of a plurality of discrete or segmented LEDs (“Light Emitting Diodes”), or may comprise a graphic overlay placed over a light source.

A camera 114 may be employed to monitor the activities in the environment 102 near the apparatus 101. The output electronic signal of the camera 114 may be analyzed by the controller and may be transmitted to remote monitors. The camera 114 may be fixed position, have a wide field lens, and/or may be movable to change the field of view. The camera 114 may monitor the nearby activities and may be employed to detect unauthorized persons after typical school hours.

A microphone 112 may be employed to monitor and electronically transmit sounds from the environment 102 near the apparatus. In an embodiment, the controller 340 in the apparatus (see FIG. 7) receives the electrical signal from the microphone 112 and may analyze the nature of the sounds being emitted near the apparatus. In an embodiment, the apparatus 101 may monitor the nearby sounds for gun. Should a gunshot be recognized, the display 120 may display a message indicating the detection of gunfire, and may communicate the event to a Main Central Controller 412 (FIG. 8) or directly to security or law enforcement (e.g. 103 or 105). Likewise, the apparatus 101 may be configured to distinguish screams from background noise. In an embodiment, the detection of an audio event may automatically activate the camera 114 so that persons in remote locations may monitor the nearby activity. In an embodiment in which a plurality of apparatuses 101 is employed, the location of the gunfire or scream may be determined by triangulating the signals from each of the apparatuses by the Main Central Controller.

In an embodiment, the apparatus 101 is configured to have voice-recognition functionality that continuously monitors background sounds for spoken words from human speakers. When the apparatus 101 recognizes that it is being addressed, the apparatus performs the commands requested by the speaker. For example, should a teacher say “Emergency, call the principal,” the apparatus 101 will recognize the speech, contact the Main Central Controller 340 in the principal's office, and facilitate communication between the teacher and the principal.

The speaker 116 may be employed to transmit voice to the apparatus 101 from remote locations (e.g., 103, 105, or 410). In an embodiment, the speaker 116 may provide audio warnings to persons near the apparatus.

FIG. 2 is a front view of the Emergency Message Alert and Monitoring Apparatus 101 attached to a wall 10. The apparatus 101 may be of various forms such as in the form of a housing configured for mounting to a wall, a housing configured to mount to a corner of two adjacent walls, or as a desktop unit for example. The apparatus may be controlled via wireless communications 210 such as Wi-Fi to devices such as devices 200 and 240.

In an embodiment, a control box 200 communicates to the apparatus 101. The control box 200 may have buttons where a user, such as a teacher in a classroom, may communicate the occurrence of an emergency event. In an embodiment, the control box may have a button for reporting a fire 202, a button for reporting a shooting 204, and a button for reporting a medical emergency 206. Other buttons 208 may be employed in one or more embodiments.

In an embodiment, a handheld device 240 such as a smartphone or tablet may be employed. In an embodiment, the smartphone is running an application (“app”) which enables the smartphone to communicate with and control the apparatus.

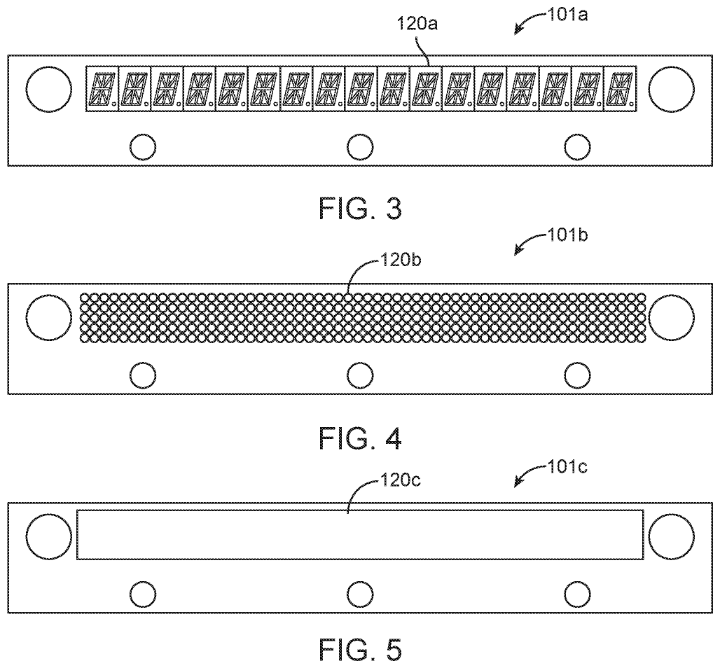

FIG. 3 is a front view of an apparatus 101a employing a plurality of segmented LED displays 120a, in this case a plurality of 16 segmented LED displays. FIG. 4 is a front view of an apparatus 101b employing a matrix of LEDs 120b. In an embodiment, a predetermined, generic message may be displayed such as “EMERGENCY ALERT!” for example. In a preferred embodiment, the system can generate specific messages to the public, such as “SCHOOL LOCKDOWN,” “FIRE ALERT,” or “EARTHQUAKE” for example. The system may be configured to provide a scrolling or “news ticker” message, enabling longer messages to be provided to the public.

FIG. 5 is a front view of an apparatus 101c employing a display screen 120c. While reference is made herein to displays comprising LEDS, it shall be understood that other displays such as LCD, electroluminescent displays, OLEDs, and plasma displays are contemplated in one or more embodiments.

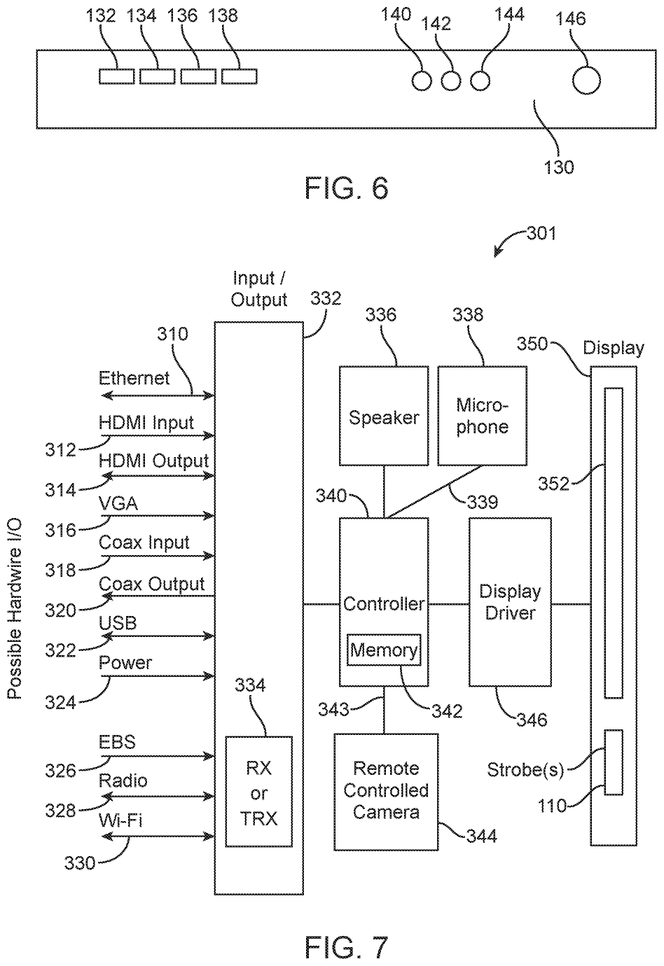

FIG. 6 is a back view of an apparatus 101. On the back side, embodiments may have one or more of the following: an Ethernet connection 132, a HDMI output 134 (“High-Definition Multimedia Interface,” output to LCD monitor), a HDMI input 136 (input from other Media device), a VGA 144 (“Video Graphics Array,” Input from other Media Device), a USB port 138 (“Universal Serial Bus,” input Media device. Media is on USB Memory), and a Power Input 146. Embodiments may also have a coaxial input 140 from other Media sources. Some locations already using broadcasting like coaxial cable like the old satellite receivers. Embodiments would take that signal and directly feed a LCD monitor (not shown) until there is an emergency. Embodiments may also have a coaxial output 142—output to LCD.

FIG. 7 is a schematic, block diagram of the apparatus 301. The apparatus may comprise one or more of the following including an input/output device 332 or devices, a controller 340 with memory 342, a display driver 346, a display 350, one or more strobe lights 110, a sound detection device 338 such as microphone, a speaker 336, and a remote controlled camera 344. The input/output device or devices 332 may support an Ethernet connection 310, HDMI (both HDMI input 312 and HDMI output 314), a VGA connection 316, coaxial connections (Coaxial input 318 and Coaxial output 320), and a USB port 322. The controller 340 may comprise a microprocessor, a digital signal processor, or other types of controlling devices in one or more embodiments. The controller receives and transmits information via the Input/Output circuitry 332 or device, and controls the display driver to display a message on the display when appropriate. In one or more embodiments, the system may further comprise a receiver (“RX”) or a transceiver (“TRX”) 334. Embodiments may be configured to receive government emergency alerts such as the “Emergency Broadcast System” 326. Embodiments may include connections for radio 328 and Wi-Fi 330.

In one or more embodiments, the apparatus 301 may be configured to receive and transmit data using wireless local networking such as Wi-Fi 330. Such a system 301 would be able to communicate via wireless access points common in many public areas such as schools. This apparatus 301 may be able to obtain Internet access and monitor emergency or government websites for emergency information.

As discussed above, the apparatus also may have a microphone 338, a speaker 336, and a camera 344 communicating with and controlled by the controller 342. The controller 342 is configured to receive the signals 339 from the microphone 338, analyze the signals 339 for the occurrence of gunfire or screams, and communicate the occurrence to the remote location (e.g., 103 or 105 illustrated in FIG. 1) via the I/O device 332.

The controller 342 is configured to receive the signals 343 from the camera 344, analyze the signals for the occurrence of emergency events, and communicate the occurrence to the remote location (e.g., 103 or 105 shown in FIG. 1) via the I/O device 332. The controller 342 is configured to receive commands from remote location 103/105 via the I/O device 332 to enable and direct the camera 344 in one or more embodiments. The camera 344 may be employed to detect intruders near the apparatus during non-school hours. In an embodiment, the camera 344 may facilitate video monitoring of the area (i.e., environment 102) near the apparatus 101/301, which can document incidents that occurred in the classroom.

The controller 344 is configured for receiving commands and signals from remote locations via the I/O device, and providing the speaker with the signals for audio output. In an embodiment, when the controller determines an emergency event has occurred, it may automatically activate the camera and speaker.

Stated in other words, FIGS. 1 and 7 depict an emergency message alert and monitoring apparatus 101/301 that comprises a detection device (e.g., a sound detection device such as a microphone 338 or camera 344) for monitoring an environment 102. The detection device (338 or 344) generates a detection electronic signal (sound electronic signal 339 or camera electronic signal 343). The apparatus 101/301 further comprises a controller 340 coupled to the detection device (e.g., microphone 338 or camera 344) receiving the detection electronic signal (sound electronic signal 339 or camera electronic signal 343). The controller 340 analyzes the detection electronic signal (sound electronic signal 339 or camera electronic signal 343) for an occurrence of an emergency. The controller 340 communicates the occurrence of the emergency. The apparatus 101/301 further comprises one or more display devices 350 communicating with the controller 340, the one or more display devices 350 providing indicia of the emergency 122 (FIG. 1) to the environment 102.

In an embodiment, the detection device comprises a sound detection device 338 monitoring the audio of an environment 102, where the detection electronic signal comprises a sound electronic signal 339. The controller 340 analyzes the sound electronic signal compromises detecting a voice command from person within the environment 102. The controller 340 analyzes the sound electronic signal 339 may also compromise detecting a gun shot within the environment 102.

In one or more embodiments, the detection device comprises a camera device 344 monitoring the environment 102 and the detection electronic signal comprises a camera electronic signal 343. The controller 340 analyzes the camera electronic signal 343 compromises recognizing and detecting the presence of unauthorized persons within the environment 102.

In one or more embodiments, the one or more display devices 350 comprise an electronic visual display 352 and one or more strobe lights 110. The apparatus 101 further comprises a control box 200 configured for communicating to the controller 340. The apparatus 101 comprises a smart device 240 running an application.

FIG. 8 is a flowchart illustrating an exemplary method for monitoring an environment for an emergency. In an embodiment, an emergency message alert and monitoring apparatuses is provided that comprises a detection device for monitoring an environment, the detection device communicating a detection electronic signal, a controller coupled to the detection device receiving the detection electronic signal, and one or more display devices communicating with the controller, the one or more display devices providing indicia of the emergency within the environment (step 382). The method further comprises receiving the detection signal by the controller (step 384), analyzing the detection signal for an occurrence of an emergency within the environment (step 386) and providing an indication of an emergency occurring within the environment (step 386).

In an embodiment, the method further comprises providing a main central controller in communication with the apparatuses, and communicating the indication of an emergency to a main central controller. In an embodiment, analyzing the detection signal for an occurrence of an emergency within the environment comprises analyzing the detection signal for a voice command. Analyzing the detection signal for an occurrence of an emergency within the environment preferably comprises analyzing the detection signal for images of an unauthorized person within the environment.

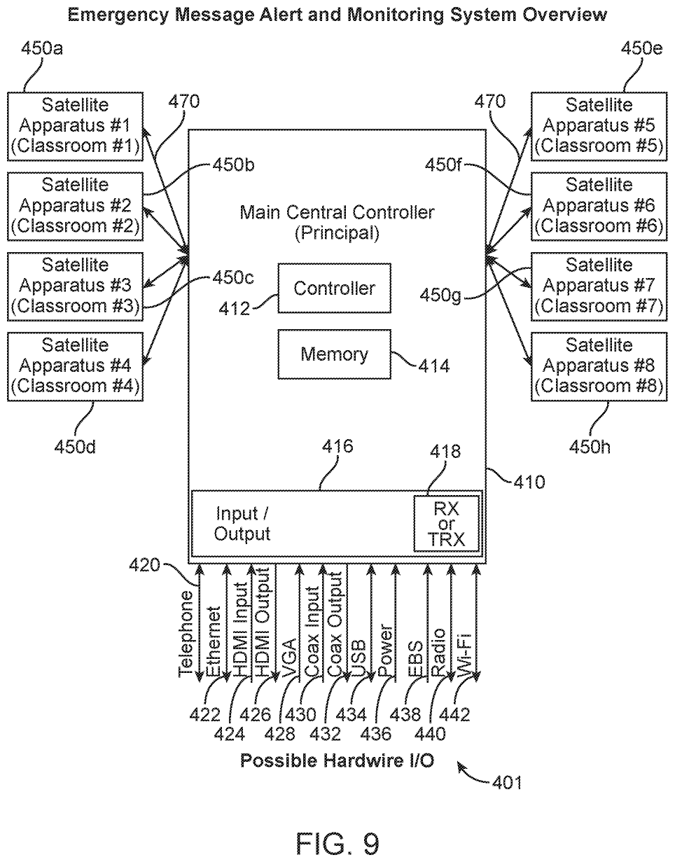

FIG. 9 is a schematic, block diagram of an Emergency Message Alert and Monitoring System 401 comprising one or more apparatuses 450a-450h in an embodiment and a Main Central Controller 410. The Main Central Controller 410 may comprise one or more of the following: a controller 412, memory 414, and Input/Output circuitry 416. While input/output circuitry 416 is shown for illustration purposes, it shall be understood that other circuits for communicating between the controller 412 and other devices are contemplated in one or more embodiments. In an embodiment, multiple satellite apparatuses (apparatuses 1-8, 450a-450h, as shown) may be employed where each apparatus may be placed in different locations such as in different classrooms. Each apparatus 450a-450h is in communication with the Main Central Controller 410 which may be placed in the school office, the principal's office, or in the school security office for example. The Main Central Controller 410 is coupled to an Input/Output device 416 which may communicate to the outside world. The Input/Output device or devices 416 may support cellular or land telephone connection 420, an Ethernet connection 422, HDMI Input 424, HDMI Output 426, a VGA connection 428, coaxial input connections 430, coaxial output connection 432, a USB port 434, and a Power Input 436. The controller 412 may comprise a microprocessor, a digital signal processor, or other types of controlling devices in one or more embodiments. The controller 412 receives and transmits information via the Input/Output device 416, and controls the display driver 350 to display a message 122 on the display when appropriate. In one or more embodiments, the system may further comprise a receiver (“RX”) or a transceiver (“TRX”) 418. Embodiments may be configured to receive government emergency alerts such as the “Emergency Broadcast System” 438, through radio 440, or Wi-Fi 442.

Hence several functions may be performed by this system. First, the system may act similar to that of a conventional public address system where audio messages are relayed between the apparatuses 450a-450h and the Main Central Controller 410. Second, should any one of the apparatuses 450a-450h detect an emergency event (e.g., gunfire or screams), the entire system 401 will become immediately activated so that the other apparatuses are notified, and outside assistance is automatically notified. Third, the Main Central Controller 410 may be able to triangulate or locate the location of the source of the gunfire or screams by comparing the signal received from the physically separated apparatuses 450a-450h.

In one or more embodiments, an emergency message alert and monitoring system 401 is disclosed. The system 401 comprises one or more emergency message alert and monitoring apparatuses 450a-450h, each apparatus comprising a detection device (e.g., a sound detection device such as a microphone 338 or camera 344) for monitoring an environment 102. The detection device (338 or 344) generating a detection electronic signal (sound electronic signal 339 or camera electronic signal 343). Each apparatus 450a-450h comprises a controller 340 coupled to the detection device receiving the detection electronic signal, the controller 340 analyzing the detection electronic signal for an occurrence of an emergency, and the controller 340 communicating the occurrence of the emergency. The apparatus 101/301 further comprises one or more display devices 350 communicating with the controller 340, the one or more display devices 350 providing indicia of the emergency 122 (FIG. 1) to the environment 102.

The system 401 further comprises a main central controller 410 communicating with each apparatus 450a-450h, the main central controller 410 communicating with remote locations (e.g., 103 or 105).

The detection device comprises a sound detection device 338 monitoring the audio of an environment 102, where the detection electronic signal comprises a sound electronic signal 339. The controller 340 analyzes the sound electronic signal compromises detecting a voice command from person within the environment 102. The controller 340 analyzes the sound electronic signal 339 may also compromise detecting a gun shot within the environment 102.

In one or more embodiments, the main central controller 410 triangulates and determines the location of the source of the sounds by comparing the signal received from the physically separated apparatuses 450a-450h. When an occurrence of the emergency is detected by the one or more apparatuses 450a-450h, the main central controller 410 immediately activates the one or more apparatuses 450a-450h, and communicates the occurrence to remote locations 130 or 105.

In one or more embodiments, the detection device comprises a camera device 344 monitoring the environment 102 and the detection electronic signal comprises a camera electronic signal 343. The controller 340 analyzes the camera electronic signal 343 compromises recognizing and detecting the presence of unauthorized persons within the environment 102. In one or more embodiments, the one or more display devices 350 comprise an electronic visual display 352 and one or more strobe lights 110.

Although the invention has been discussed with reference to specific embodiments, it is apparent and should be understood that the concept can be otherwise embodied to achieve the advantages discussed. The preferred embodiments above have been described primarily as an emergency message alert and monitoring apparatus and system for alerting people during an emergency. In this regard, the foregoing description of the emergency message alert apparatus and system is presented for purposes of illustration and description. It shall be apparent that other media or public events would benefit from the emergency message alert system.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. An emergency message alert and monitoring apparatus, the apparatus comprising:
a detection device for monitoring an environment, the detection device generating a detection electronic signal;
a controller coupled to the detection device receiving the detection electronic signal, the controller analyzing the detection electronic signal for an occurrence of an emergency, the controller communicating the occurrence of the emergency; and,
one or more display devices communicating with the controller, the one or more display devices providing indicia of the emergency to the environment.

2. The emergency message alert and monitoring apparatus of claim 1, wherein:
the detection device comprises a sound detection device monitoring the audio of an environment; and,
the detection electronic signal comprises a sound electronic signal.

3. The emergency message alert and monitoring apparatus of claim 2, wherein the controller analyzes the sound electronic signal comprises detecting a voice command from a person within the environment.

4. The emergency message alert and monitoring apparatus of claim 2, wherein the controller analyzes the sound electronic signal comprises detecting a gun shot within the environment.

5. The emergency message alert and monitoring apparatus of claim 1, wherein:
the detection device comprises a camera device monitoring the environment; and
the detection electronic signal comprises a camera electronic signal.

6. The emergency message alert and monitoring apparatus of claim 5, wherein the controller analyzes the camera electronic signal comprises recognizing and detecting the presence of unauthorized persons within the environment.

7. The emergency message alert and monitoring apparatus of claim 1, wherein the one or more display devices comprises:
an electronic visual display; and,
one or more strobe lights.

8. The emergency message alert and monitoring apparatus of claim 1, further comprising a control box configured for communicating to the controller.

9. The emergency message alert and monitoring apparatus of claim 8, wherein the control box comprises a smart device running an application.

10. An emergency message alert and monitoring system, the system comprising:
one or more emergency message alert and monitoring apparatuses, each apparatus comprising:
a detection device for monitoring an environment, the detection device generating a detection electronic signal;
a controller coupled to the detection device receiving the detection electronic signal, the controller analyzing the detection electronic signal for an occurrence of an emergency, the controller communicating the occurrence of the emergency; and,
one or more display devices communicating with the controller, the one or more display devices providing indicia of the emergency to the environment; and,
a main central controller communicating with each apparatus, the main central controller communicating with remote locations.

11. The emergency message alert and monitoring system of claim 10, wherein:
the detection device comprises a sound detection device monitoring the audio of an environment; and,
the detection electronic signal comprises a sound electronic signal.

12. The emergency message alert and monitoring system of claim 11, wherein the main central controller triangulates and determines the location of a source of sounds by comparing the signal received from the apparatuses

13. The emergency message alert and monitoring system of claim 11, wherein when an occurrence of the emergency is detected by the one or more apparatuses, the main central controller immediately activating the one or more apparatuses, and communicating the occurrence to remote locations.

14. The emergency message alert and monitoring system of claim 10, wherein:
the detection device of the one or more apparatuses comprises a camera device monitoring the environment; and
the detection electronic signal comprises a camera electronic signal.

15. The emergency message alert and monitoring system of claim 14, wherein each controller of the one or more apparatuses analyzes the camera electronic signal comprises recognizing and detecting the presence of unauthorized persons within the environment.

16. The emergency message alert and monitoring system of claim 10, wherein the one or more display devices of each of the apparatuses comprises:
an electronic visual display; and,
one or more strobe lights.

17. A method for monitoring an environment for occurrences of an emergency, the method comprising:
providing an emergency message alert and monitoring apparatuses comprising a detection device for monitoring an environment, the detection device communicating a detection electronic signal, a controller coupled to the detection device receiving the detection electronic signal, and one or more display devices communicating with the controller, the one or more display devices providing indicia of the emergency within the environment;
receiving the detection electronic signal by the controller;
analyzing the detection electronic signal for an occurrence of an emergency within the environment;
providing an indication of an emergency occurring within the environment.

18. The method for monitoring an environment for occurrences of an emergency of claim of 17, further comprising
providing a main central controller in communication with the apparatuses; and,
communicating the indication of an emergency to a main central controller.

19. The method for monitoring an environment for occurrences of an emergency of claim 17, wherein analyzing the detection signal for an occurrence of an emergency within the environment comprises analyzing the detection signal for a voice command.

20. The method for monitoring an environment for occurrences of an emergency of claim 17, wherein analyzing the detection signal for an occurrence of an emergency within the environment comprises analyzing the detection signal for images of an unauthorized person within the environment.
